(19) United States
(12) Patent Application Publication
(10) Pub. No.: US 2010/0208313 A1
(43) Pub. Date: Aug. 19, 2010

(54) SECURITY AND SENSING ELEMENTS WITH VOLUME HOLOGRAMS

(76) Inventors: Adrian M. Horgan, Cambridge (GB); Mark Giles, Cambridge (GB); John D. Wiltshire, Colchester (GB)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 12/372,315

(22) Filed: Feb. 17, 2009

(51) Int. Cl. B44F 1/12; G03H 1/02; G03H 1/26

(52) U.S. Cl. 359/2; 359/3; 359/22

(57) ABSTRACT

The nature of a volume hologram limits its use in security and sensing applications. Accordingly, a volume hologram segregated into a first and second region recording a first and second image, respectively, and wherein the second region is responsive to stimulus while the first region is protected physically from stimulus is provided. Also provided is a volume hologram with a functional cover disposed thereon to regulate how the volume hologram interacts with the stimulus when in the presence of stimulus. A volume hologram with a removable cover disposed thereon to permit a first recorded image to be viewed, to protect the volume hologram from physical damage, to prevent the volume hologram from interacting with the stimulus, and to be removed, thereby permitting the volume hologram to interact with the stimulus is provided as well. In these ways, the usability of volume holograms in security and sensing applications is increased.

### BACKGROUND OF THE INVENTION

In the security industry aluminized embossed foil relief holograms have been used as security holograms to provide indicia of authenticity. A security hologram may contain novel features which are difficult for a counterfeiter to compromise and preferably features that will attract the attention and interest of a viewer. However, a skilled amateur counterfeiter may have the ability to illicitly reproduce an image of a simple reflection hologram common to aluminized embossed foil relief holography. This compromises the ability for such holograms to secure articles of value and limits their ability to identify genuine products or documents from counterfeits.

Volume holograms can be used as sensors (see, e.g., WO95/26499). When a volume hologram interacts with an analyte or external stimulus, a change in a physical property of the support medium occurs, resulting in a detectable change in the optical characteristics of the holographic element. Most of the systems of this type require interaction of the volume hologram with a solution-based analyte. This poses certain problems. To be responsive to a solution based system the recording material should be exposed. But this causes durability and stability issues because mechanical damage may occur to the recording material, and in the case of silver halide materials, silver drop out (“print out”) may occur due to exposure to ultra violet radiation. Exposure of a surface of a volume hologram to the environment also make it substantially easier for the holograms to be fraudulently reproduced by contact copying. For example, when a volume hologram that is responsive to a external stimulus, and the thickness of the volume hologram and the replay color of the holographic image change in the presence of the external stimulus, exposure of the volume hologram to the environment can make it easier for a counterfeiter to effectively “tune” a component of the holographic image to the precise color of a laser being used for illicit contact copying of a secure hologram. Additional problems that can limit the effectiveness of security holograms is unauthorized copying of the hologram, unauthorized reuse and unauthorized transfer of a security hologram from one object to another.

It would be beneficial to provide techniques and devices that address these problems.

### SUMMARY OF THE INVENTION

According to an aspect of the invention there is therefore provided a volume reflection hologram in which two images are recorded, a first image in a first physical region of the hologram and a second image in a second physical region of the hologram different to the first region, wherein the second region of the hologram is responsive to an external stimulus to change the appearance of the second image, and wherein the hologram is configured to protect the first region of the hologram physically from the external stimulus.

In some embodiments the first and second regions comprise surface regions of the hologram, and a protective covering is provided over the first region to protect the first region from the external stimulus. In this way the first image may be viewed substantially unchanged whilst the second is modified by the external stimulus. In embodiments the protective covering comprises a protective film over the hologram, permeable or perforated where it covers the second region of the hologram. Optionally, but preferably, the film also blocks 10%, 20% or more of incident ultraviolet (UV) light, for example at a wavelength of less than 400 nm. This helps to protect the hologram from degradation.

In embodiments there may be multiple stimulus-responsive and/or multiple static images. For example there may be two perforated areas or windows, providing a security element with an image that does not change and another image that can change.

To provide increased security the protective covering or film may be birefringent, that is having different refractive indices in major and minor (ordinary and extraordinary) directions within the film plane. For example the protective covering may have a birefringence of at least 0.01, 0.02, 0.03, 0.04, 0.05, 0.06 or more. An example of a suitable birefringent material is polyester film (in which the birefringence may be enhanced by stretching in the plane of the film).

In another embodiment the hologram comprises a carrier or substrate (or film base) bearing a layer of holographic recording medium on both its front and back surfaces, allowing one of the first and second images to be recorded in the recording medium on one side of the film carrier, and the other to be recorded in the recording medium on the other side of the carrier. The first region in which the unchanging image is recorded is preferably provided with an adhesive layer or coating to enable it to be attached to a surface, thereby inhibiting the external stimulant from accessing the recording medium storing the first image.

Preferably the film carrier is substantially non-birefringent, to enable the first image to be recorded through the side of the film bearing the second layer of recording medium for storing the second image. This is further facilitated if the first and second recording media have recording sensitivities at different wavelengths. More particularly it is preferable that the second holographic recording medium is more sensitive in the blue than the first recording medium (which may be mono-, bi-, or poly-chromatic). The film carrier may also be selected to inhibit transmission of light at a blue wavelength, for example by greater than 10% or 20% at a wavelength of less than 450 nm or 400 nm. In this way a red, green or multi-color image may be recorded in the first recording medium and a blue or ultraviolet image in the second recording medium. Thus, preferably, the film substrate or base is at least partially transmissive in the blue.

Embodiments of this type are particularly useful as they enable the second image to be substantially invisible to a human observer and to effectively appear by changing color from a substantially invisible blue or ultraviolet towards a green or even red, which is perceived as much brighter. However in other embodiments there may be a color change between two visible colors or the second image may substantially disappear rather than appear in response to an external stimulus. In some embodiments the first image has a delineated region (not necessarily delineated by lines, however) and the second image may then conveniently be positioned to lie at least partially, preferably wholly, within this delineated region. The stimulus may comprise a liquid, for example water or alcohol, or a liquid bearing gas, for example high humidity air. Other examples of an external stimulus include: humidity, water, gases, vapors, organic solvents, chemicals, solutions or dispersions of chemicals, enzymes, biological materials and combinations of two or more thereof.

To facilitate recording a shorter wavelength image in the second region, the second recording medium may comprise silver halide with a larger average grain size (preferably a larger median size, but optionally larger mean or mode size) than that of the first recording medium. The second recording medium may have a thickness of less than 5 μm, for example in the range 2 μm to 4 μm; the first recording medium may have a thickness in the range 3 or 5 μm to 10 or 20 μm. In some preferred embodiments the second recording medium has a thickness of less than that of the first recording medium. In some preferred embodiments the second recording medium is configured to enable the recording medium to be shrunk by physical and/or chemical processing in order to shift a wavelength of the second image towards the blue after recording.

Other aspects of the invention provide:

Use of a security element or device including a hologram as described above for verification and/or identification and/or authentication and/or anti-counterfeiting purposes; or for verification and/or identification and/or authentication and/or anti-counterfeiting of a product.

A product carrying a security element or device including a hologram as described above, in particular a banknote, a passport, an identification document, a smart card, a driving license, a share certificate, a bond, a check card, a tax banderole, a postage stamp, a ticket, a credit card, a debit card, a telephone card, a lottery ticket, a gift voucher, a packing material, a decorative material, a brand product or another product which has to be secured.

A security element or device including a hologram as described above and including a further security element, in particular comprising one or more of a water mark, a laser engraving, a planchette, a fiber, a fluorescent particle, or fiber, an infra-red (IR) or ultra-violet (UV) active colorant, a magnetic particle, an electrically conductive particle, an optically variable pigment, a liquid crystal polymer (LCP) pigment, a chemical additive observable by irradiation with light of a particular wavelength or by chemical reaction or by manipulation of the substrate, a deoxyribonucleic acid (DNA)- and/or bio-coding material, an organic or inorganic taggant, or similar.

A security element or device including a hologram as described above and including a further second security element, in particular comprising one or more of a hologram, a kinegram, a laser engraving, a radio-frequency identification (RFID) element, an optically variable printing and/or an optically variable system of optically variable pigments, an optically variable thin film structure and/or liquid crystal polymers, a microtext, guilloches, a magnetic feature, an electrically conductive feature, an IR or UV active feature, a photoluminescent feature, an electroluminescent feature, a photochromic feature, a thermochromic feature, a hydrochromic feature, a tribochromic feature, a piezochromic feature, a DNA- and/or Bio-coding feature or similar.

A security element or device including a hologram as described above wherein the element or device is machine-readable. A method of verification by detecting a change in an image as described above, in particular by machine.

Features of the different above-described embodiments of the invention may be combined, in any permutation.

The invention further provides a security device incorporating a hologram as described above, and an article having a surface to which is attached a hologram as described above.

Another aspect of the invention provides a method of manufacturing a hologram as described above.

Another aspect of the invention provides a method of displaying two images using a volume hologram, a first image in a first physical region of the hologram and a second image in a second physical region of the hologram different to the first region, wherein the second region of the hologram is responsive to an external stimulus to change the appearance of the second image, the method comprising protecting the first region of the hologram physically from the external stimulus such that the first image is visible in a substantially unchanging form whilst the appearance of the second image is changed by the external stimulus. Yet another aspect of the invention provides a holographic recording system for recording a volume reflection hologram comprising two images, a first image in a first physical region of the hologram and a second image in a second physical region of the hologram different to the first region, wherein the second region of the hologram is responsive to an external stimulus to change the appearance of the second image, the holographic recording system comprising means for protecting the first region of the hologram physically from the external stimulus.

In one embodiment the means for protecting the first region of the holographic recording system physically comprises a protective covering film over the first region, preferably perforated or permeable over the second region, although in some less preferred embodiments it may simply be substantially absent from the second region. In other embodiments the means for protecting the first region physically comprises an adhesive layer or coating on the first region to enable this to be attached to a surface and hence to inhibit access of the external stimulus to the first region. In other embodiments, instead of an adhesive layer the system may be attached to a surface (preferably forming a seal) by a further layer or film over the top of the system, with a window to expose the upper recording medium.

Still yet another aspect of the invention provides a security device comprising a volume hologram as described herein and a functional cover and/or removable cover disposed over a surface of the volume hologram.

In some embodiments, the invention may be a security device that includes a volume hologram comprising a first recorded image, a second recorded image, and a surface. The surface of the volume hologram permits the volume hologram to interact with a stimulus. The security device also includes a functional cover disposed over the surface of the volume hologram. The functional cover regulates how the volume hologram interacts with a stimulus when the security element is in the presence of the stimulus, for example, by permitting interaction with water vapor but not liquid water. The functional cover can also provide other benefits, such as abrasion resistance.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIGS. 1A and 1B show an example of a security hologram which is partitioned into a main image and a second image, the second image changing under the influence of an external stimulus.

FIG. 2 shows the hologram of FIG. 1 attached to the surface of a document or article.

FIGS. 3A and 3B show examples of a security hologram according to first and second embodiments of the invention.

FIGS. 4A and 4B show the security hologram of FIGS. 3A and 3B respectively, attached to a document or article.

FIG. 5 is a side view of example sensing element having a volume hologram and a functional covers disposed over the volume hologram to regulate how the volume hologram interacts with a stimulus, in accordance with an example embodiment of the present invention.

FIGS. 6A and 6B are side views of example sensing elements with functional covers having conducting sides to conduct a stimulus to and from a surface of the volume hologram, in accordance with example embodiments of the present invention.

FIGS. 7A-7C are top-down views of example removable covers with tabs, in accordance with example embodiments of the present convention.

FIG. 8 is a perspective of an example security element, in accordance with an example embodiment of the present invention.

FIGS. 9A-9C are side views of example removable covers configured to associate a security element to an article, in accordance with an example embodiment of the present invention.

FIG. 10A is a side view of an example security element with an adhesive layer deposited between a volume hologram and a removable cover, in accordance with an example embodiment of the present invention.

FIG. 10B is a top-down view of an example security element and a removable cover removed from the security element, in accordance with an example embodiment of the present invention.

FIG. 11 is a side and top-down view of a volume hologram attached to an object in a manner that hinders unauthorized copying and/or reuse, in accordance with example embodiments of the present convention.

FIG. 12 is a side and top-down view of a volume hologram attached to an object in a manner that hinders unauthorized copying and/or reuse, in accordance with example embodiments of the present convention.

FIG. 13 shows a vertical cross-section through a third embodiment of a security hologram according to the invention.

### DETAILED DESCRIPTION OF THE INVENTION

A description of example embodiments of the invention follows.

The term “stimuli-responsivity” as used herein refers to a characteristic change in the physical and optical properties of a volume hologram when the volume hologram interacts with an appropriate stimulus.

The term “conduct” as used herein means to act as a medium for conveying or transmitting a stimulus to and/or from a surface of a volume hologram.

The invention broadly relates to a sensor or security device comprising a volume hologram that is responsive to stimuli and an over coating or cover that is protective, functional and/or removable disposed over the volume hologram. The cover generally protects the recording material of a volume hologram from abrasion, the environment or selected components of the environment, and optionally regulates the interaction of the volume hologram with a stimulus (e.g., liquid water, water vapor). In one aspect, the cover contains perforated or semi-permeable areas, and in some embodiments the cover is in registration with the hologram that it covers. This means that only certain areas of the volume hologram are exposed or accessible to a stimulus, such as a chemical stimulus, through the perforated or semi-permeable areas of the cover, while other areas are protected from stimulus by impermeable areas of the cover.

In another aspect, the volume hologram comprises two-sided recording material, which enables the recording material on one side to be protected by the base carrier film, while the coating on the second side of the base is accessible to a stimulus. The need to prevent unauthorized copying or forgery of volume holograms put extra demands upon the recording layer (e.g., silver halide layer). This provides for a second layer of recording emulsion that reinforces the image from the first layer, to improve the brightness of all the components of the image and with the advantage that the primary image of the final hologram is substantially isolated from the external environment by the base carrier layer, which is selected to be substantially impervious (e.g., to chemicals and moisture). Thus the primary hologram image, sealed behind the base carrier layer, can retain a consistent image throughout the application of a stimulus (e.g., a chemical stimulus) to the device, whereas the image in the second coated layer on the other side of the base is subject to color change or switching of the graphic image.

In another aspect, the cover is removable. For example, an impermeable cover can be configured to be removable from the volume hologram, thereby protecting the volume hologram from stimuli until removed. Preferably, a removable cover is configured to hinder unauthorized copying of the volume hologram, as described herein.

Described herein are techniques for protecting the recording material of a volume hologram that is responsive to stimuli. One technique uses an over coating (e.g., a cover) that is perforated, permeable, or semi permeable in registration with the hologram it is covering. This means that only certain areas of the recording material are effectively exposed to an applied external or environmental stimulus such as a chemical stimulus, whilst other areas are protected from this stimulation. This may be referred to as “stimulus masking.” A second technique involves the use of a two-sided recording material that enables the recording material on one side only to be fully protected by the base carrier film, whilst the coating on the second side of the base is exposed to the chemical stimulus.

The techniques needed to hinder or prevent forgery put extra demands upon the recording layer of a volume hologram (e.g., silver halide recording layer) and the second technique enables a second layer of recording emulsion to reinforce the image from the first layer, thereby improving the brightness of all the components of the image and with the advantage that the primary image of the final hologram is substantially isolated from the external environment by the carrier layer, which is largely impervious to chemicals and moisture. Thus the primary hologram image, sealed behind the base carrier layer, can retain a consistent image throughout the application of any chemicals to the device, whereas the image in the second coated layer on the other side of the base is subject to color change or switching of the graphic image.

Consider a holographic sensor which responds to analytes in solution (although this is not an essential feature of embodiments of the invention). Such a hologram therefore comes into contact with the test solution. If the recording material is totally open, durability problems through abrasion and other wear can result. If a silver halide material is used there is also the possibility of silver “print out” (i.e., a darkening of the recording material over time when exposure to blue and ultraviolet (UV) light causes silver metal to be precipitated). The need for an open surface therefore prevents covering of the material with a UV blocking layer. If the sensor hologram is to be used as a security feature there is a further consideration to take into account. One method of counterfeiting is to “contact copy” an original hologram. Methods are known to reduce this risk, but an open surface would enable the replay color of the hologram to be controlled by the swelling of the recording material resulting in a less secure hologram.

Now consider a responsive device that has the property that as well as having a visible primary image it is sensitive to a specific stimulus such that when activated, it causes, for example, the appearance of a secondary image which may also be three-dimensional, multi-channel or animated. Preferably, this secondary image is formed within the same displayed image space as the primary image, but is designed to fit into a “void” or available zone in the primary image so that it is clearly visible to the observer.

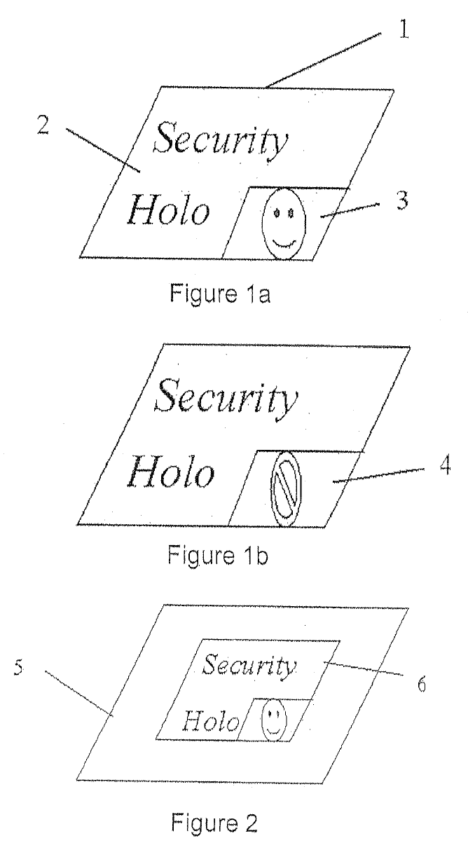

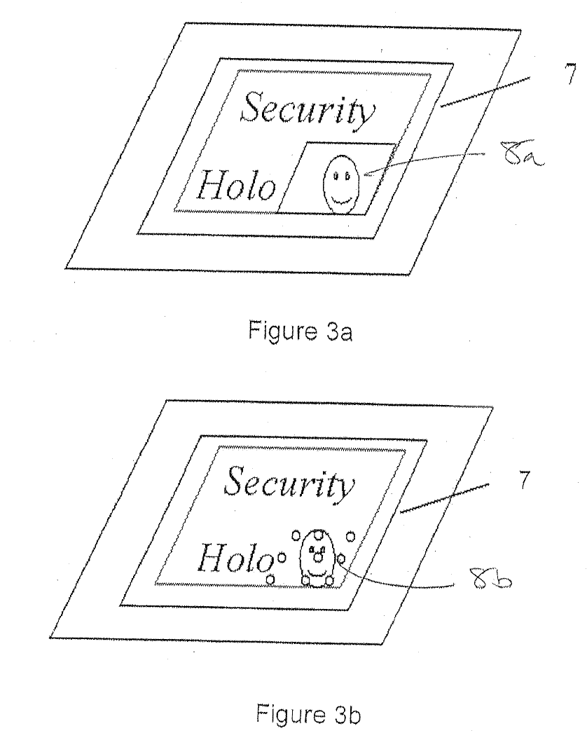

FIG. 1 shows a security hologram 1 of this type, which is partitioned into a main image 2 and a second image 3 that changes when a stimulus is applied. FIG. 1B shows the stimulated hologram with the changed image 4. The skilled person will understand that here the different spatial regions of the hologram store different images—unlike a conventional hologram in which each part of the hologram is capable of reproducing the whole recorded image, albeit at reduced resolution. FIG. 2 shows the complete security hologram 6 fixed to an item of value 5.

The site of the covert holographic image may be delineated by the presence of an overt image component, perhaps in one particular corner of the image field, which is not filled with animated or multi-colored image components. A simple outline image, for example, of a classical symbolic security icon such as a padlock, is seen in the corner of a hologram, and when this image area is treated with a particular external stimulus (e.g., a liquid, a chemical solution), it will result in the appearance of a bright image, say green in color to ensure high impact upon the observer, of, for example, a key, or other security symbol, in the area delineated by the padlock outline.

In one embodiment, a security hologram is provided which is designed and manufactured using a standard single sided emulsion so that only a selected small area of the complete hologram is designed to respond to a stimulus, by for instance one image disappearing and being replaced with a second different image. The security hologram when placed on an item of value could be covered with a protective film that has a semi-permeable (porous) or perforated area that is in registration with the section of the hologram designed to respond to the stimulus. The bulk of the security hologram is then protected from the elements and the film will also inhibit large scale swelling of the film by counterfeiters. A substantially birefringent cover film can be used to also make contact copying difficult or impossible.

In other embodiments, the covert image is incorporated into the same area of recording film as the overt full color image or other permanently visible image, in such a way as to enable the activation of the covert image without substantial detriment to the permanence of the full color image. These embodiments modify the film base and/or coating used for the hologram, in combination with an exposure technique involving multiple laser illumination wavelengths which exploit the varying levels of spectral sensitivity of the film assembly.

Depending on how the stimulus-responsive image is arranged the changing image may be detected by the unaided human eye or with the assistance of magnifying lenses, microscopes, lenticular lenses, polarizing filters, diffractive structures, wavelength filter elements, light enhancing systems, or the like, or by optical detectors such as spectrophotometers, spectrum analyzers, charge-coupled device (CCD)-sensors, complementary metal-oxide-semiconductor (CMOS)-sensors, optical character recognition (OCR)-readers, bar code readers, cameras and image recognizers, or a combination of these. The image may be an image of, for example and without limitation, one or more of: an alphanumeric or similar character, microtext, a picture, a photo, a bar code, a physical object, a logo, a trade mark, a computer generated picture, a computer generated object and projections thereof. The image may include or consist of a mirror or reflective surface. As previously mentioned, in embodiments there may be multiple stimulus-responsive and/or multiple static images. The change in the image may be reversible, partly reversible or irreversible.

### First Technique

There are a number of ways that a spatially registered protective film coating may be manufactured. A complete film may be placed on the hologram and laser cutting or spark etching used in-situ to perforate the film to achieve porosity in the required areas. Alternatively the cover film may be pre-prepared with either a window or perforations; and the film then placed in registration on to the hologram once fixed on the item of value to be protected. In a roll-to-roll process the security holograms may be produced in the form of a “sticker” so that the hologram and over coat are combined in one unit which can then be fixed to an item of value. It will be appreciated that such a hologram may also be incorporated into a label or a security element or device such as a patch, thread, window and the like.

The film may be made of any suitable material to resist the test solution, preferably with good transparency and low birefringence—for example triacetate may be employed for water resistance whilst a polyester-type material (e.g., polyethylene terephthalate (PET)) may be employed for a degree of isopropyl alcohol (IPA)-resistance. Other materials may be selected according to the application. The film thickness is a trade-off between optical properties and solvent resistance and is preferably less than 100 μm, more preferably less than 50 μm. Preferably the thickness is greater than 5 μm or 10 μm.

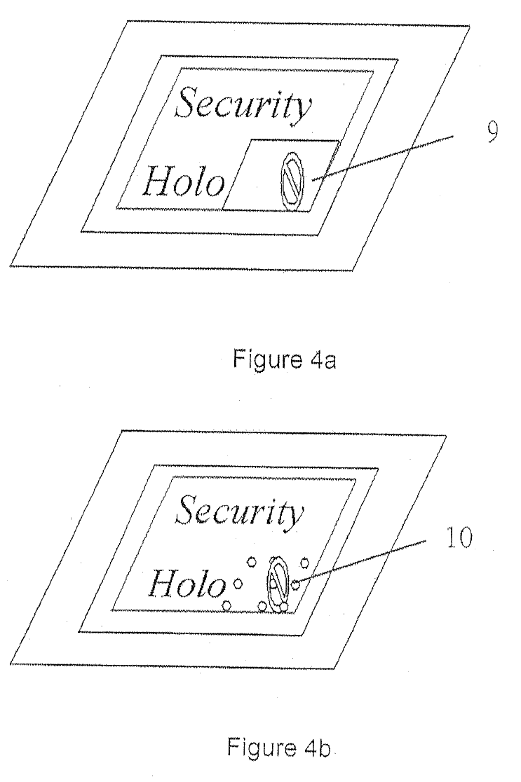

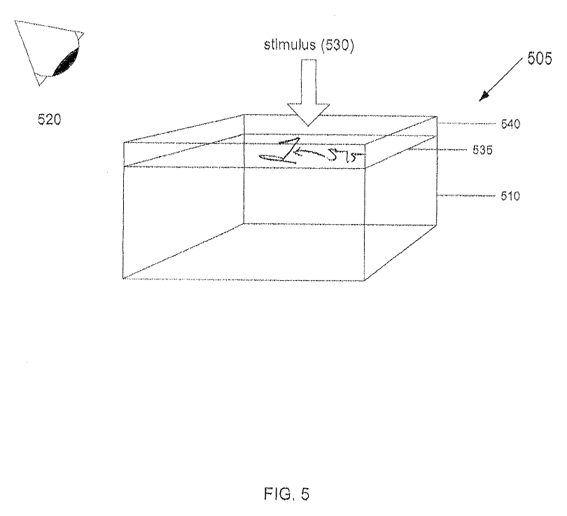

FIGS. 3A and 3B show examples of complete security holograms according to embodiments of the invention fixed to an item of value and covered with a protective layer 7 with, respectively in FIGS. 3A and 3B, a window 8a and a perforated protective layer 8b, both exposing the ‘smiley face’ image to an external stimulus. FIGS. 4A and 4B show an example of a complete security hologram fixed to an item of value and covered with, in FIGS. 4A and 4B respectively, a protective layer with a window 9 and a perforated protective layer 10, both responding to a stimulus.

### Second Technique

In the photographic industry silver halide emulsion layers may be coated on both sides of a carrier film in order to allow an increased silver coating weight. For example X-ray emulsions by 3M, KODAK and DU PONT were coated on both sides of a carrier film (G. Duffin: Photographic Emulsion Chemistry). All commercially available holography emulsions, such as the SO173 from KODAK, ILFORD SP673, 8E56 and 8E75 by AGFA GEVAERT, PFG01 by SLAVICH, FHL by FUJI HUNT, and HF53 by ORWO, however, are coated single sided on a carrier typically comprising polyethylene terephthalate (PET) or triacetate. Photopolymer recording materials, such as DMP 128 from POLAROID, and IZON from DU PONT are coated as a protective sandwich between two carrier films as it is necessary to eliminate air. Holography importantly involves the use of polarized laser light and thus non-birefringent triacetate cellulose (TAC) is preferable to polyester carriers, which tend to create difficulties in all but the thinnest layers.

Hologram efficiency trialling (Solymar, L and Cooke, D J, Volume holography and volume gratings, London Academic press, 1981) has indicated that the difficulties in producing a layer of emulsion 20 μm thick are not justified for display holography since an emulsion layer of just 8μ will provide a high level of diffraction efficiency sufficient for all but the most technical applications. Indeed Soviet authors (Petrov, V D, Zhumal Nauchnoi Prikladnoi Fotografii Kinematografii 1976, 21(2) 144-5) demonstrated that for Russian fine grain emulsions, of similar crystal size to the best modern materials, in some cases diffraction efficiency was inversely proportional to thickness, and they recommended 3-10 micron as the optimum thickness. Holographic optical elements (HOEs) used for example as head-up displays in fighter aircraft made by PILKINGTON HOLOGRAPHICS, St. Asaph, Wales have utilized thick layers of di-chromated gelatine (DCG) of the order of 20μ to achieve holograms with close to 100% reflective efficiency for a narrow band of wavelengths so as to achieve almost perfect reflectivity of light from an instrument panel whilst permitting simultaneously almost 100% transmissive view of the exterior scenery.

It is common in photographic applications to produce multi-layer coatings of gelatin based emulsions and a common practice to overlay the photosensitive layer with a plain gelatin over layer, often known as super-coat or “non-stress”. Thus the various layers or strata of color sensitive emulsions are overlaid with an inert gelatin layer which protects the sensitive layers from physical damage. Such physical damage could be caused by a film transport system or by the manual handling of the film. Such treatment could cause developable zones to appear on the surface of the film in photography, which results in image defects. Such defects could be interpreted with catastrophic results in x-ray examination.

Companies such as AGFA and ILFORD have preferred to utilize the whole of the layer with active ingredients rather than to use an inert super-coat. Such a super-coat on a conventional photographic material will sometimes contain an ‘anti-bloc’ medium such as silica of a selected grain size which has the function of preventing the layer from sticking to the next sheet in a film package or to the adjacent winding on the roll. However, such particles of silica or similar material are incompatible with the holography process since they will scatter the rays of a laser beam, particularly when the film is used for recording the interference associated with blue laser light.

Holographic recording materials to date have been predominantly monochromatic in their spectral sensitivity. For example, COLOUR HOLOGRAPHIC LTD., Maldon, Essex, supply recording plates for holography designated BB 450, BB520 and BB640. These materials contain sensitizing dyes suitable to achieve actinic effect with blue, green and red lasers respectively, where the suffix digits refer to the approximate wavelength, in nanometers, of the peak sensitivity of the dyed emulsion. Recent panchromatic materials produced by FUJI-HUNT and COLOUR HOLOGRAPHIC have utilized a single layer of active emulsion.

Recording materials are generally coated onto a low birefringent carrier film to give mechanical stability. Coating the active emulsion on one side can cause the base to flex and distort. One well established method to prevent this is to coat a blank non-sensitive layer of the support polymer on the opposite side of the film base from the active layer; this then balances up the distortion and gives a flat film. This has been used by FUJI on their recently released holographic recording film. This second gelatin layer offers a balancing effect on the assembly with the result that curling properties of the film are considerably reduced when the film is subjected to varying conditions of heat and humidity. A layer of this type in a photographic product could also typically contain anti-bloc particles but as described previously this would be incompatible with holography.

Further embodiments of the invention are described next.

An alternative method of protecting a security hologram, but still allowing response to stimuli, is to coat active recording material on both sides of the base film and to provide an adhesive layer on one side. One side preferably has a panchromatic recording material into which a complex security hologram can be shot or otherwise recorded. On the other side the recording material is responsive to a stimulus. A further image or images can be shot into this side, which changes when the stimulus is applied. Holograms may be selectivity shot in each side by varying the spectral sensitivity of the recording material so that the reactive side of the hologram is sensitized to a laser line that the other recording material is not. When this hologram is attached to an item of value the first hologram is placed face down with the base film on top and is therefore protected from wear and tear. The active hologram is then on the outside, but this arrangement means that if the surface is damaged the hologram underneath will still be intact. This “double” system also makes it much harder for the holograms to be copied.

In other aspects, the invention relates to sensors or security devices comprising a volume hologram, with one image, or more than one image recorded as described herein, with a functional and/or removable cover disposed over at least a portion of the volume hologram. The functional cover can, for example, be perforated (e.g., contain pores or micropores) and/or semi-permeable. In addition to providing protection from physical damage, such as damage from abrasion, a functional cover can regulate the interaction of the volume hologram with the environment or a stimulus and conducts, moves or permits the movement of a stimulus to and/or from the volume hologram. For example, the functional cover can restrict accessibility to the volume hologram and/or regulate the rate of access or rate of removal of the stimulus. In one example, the functional cover is permeable to vapor but not liquid (e.g., permeable to water vapor but impermeable to liquid water). This type of functional cover can, for example, regulate the rate at which a “wet” volume hologram dries, thereby regulating the rate at which a dry holographic image appears. In another example, the functional cover resists conducting the stimulus to the volume hologram. In this example, the stimulus contacts the volume hologram when a driving force sufficient to overcome the resistance of the functional cover is present. Examples of suitable driving forces include pressure, ionic gradient, concentration gradient, and the like. This type of functional cover is advantageous in applications where it is desirable for the volume hologram to interact with stimulus under controlled or particular conditions. If desired, a functional cover can be configured to be removable as described herein.

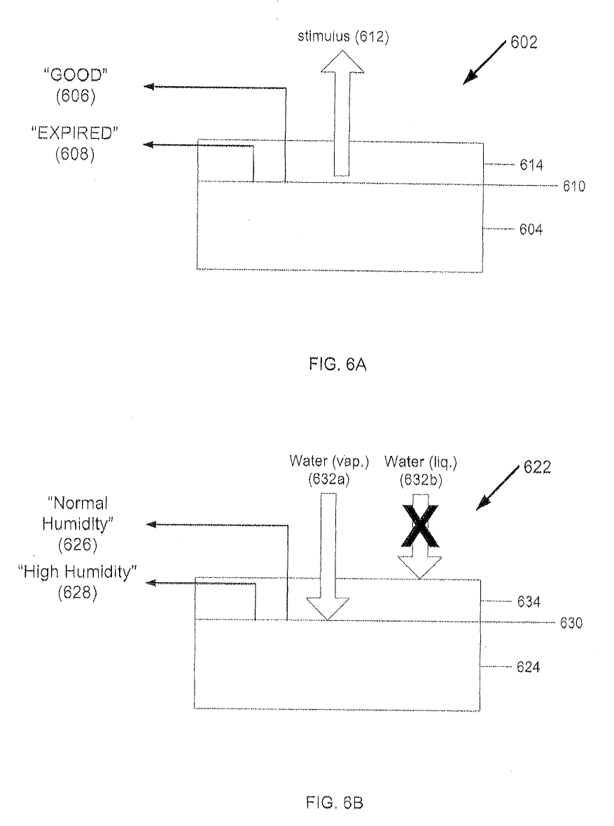

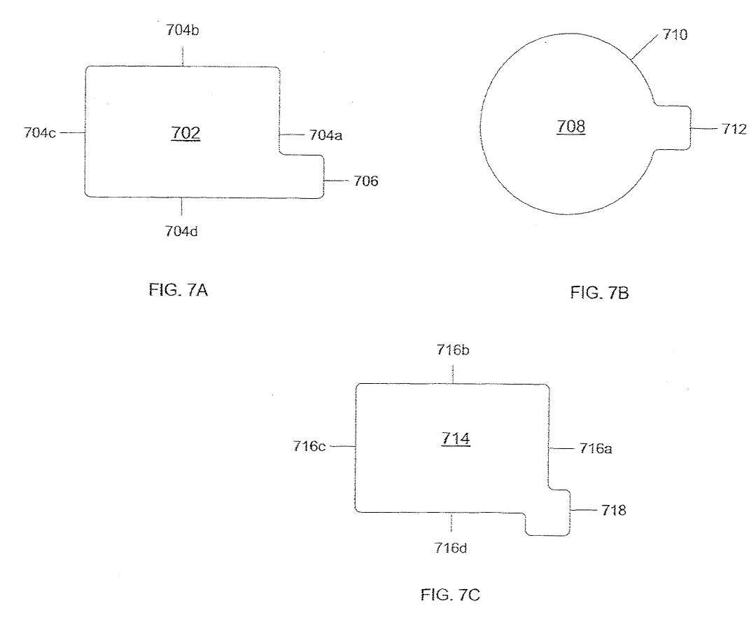

Example embodiments of sensors or security devices that comprise a functional cover are described with references to FIGS. 5 and 6A-6B. In these example embodiments, the volume holograms are sensors that can detect a stimulus or a property of the stimulus, for example, a level of a substance to be analyzed. The example embodiments shown in FIGS. 5 and 6A-6B may represent the sensor or security device or a stimulus-responsive portion or region thereof.

In FIG. 5, a sensor or security device 505 includes a volume hologram 510 with a first recorded image 515 presently viewable to a viewer 520 and at least one second recorded image (not shown) viewable after the volume hologram 510 interacts with a stimulus 530. The volume hologram 510 can interact with the stimulus 530 at a surface 535. For the sake of convenience, the surface 535 may be referred to as an “interactive surface.” When the stimulus is a liquid, it is convenient to refer to the first image as a “dry” image when it is recorded and visible in a dry volume hologram, and to refer the second image as a “wet” image when it is recorded and visible in a wet volume hologram.

Continuing with FIG. 5, the security element 505 also includes, disposed over the surface 535, a functional over coating or cover 540. In one example, the functional cover is permeable to vapor but not liquid (e.g., permeable to water vapor but impermeable to liquid water). Such functional covers can, for example, be used to make devices intended to detect vapors or gases but not liquids, or to regulate the rate at which a wet volume hologram dries, thereby regulating the rate at which a dry holographic image becomes visible.

As described below with reference to FIGS. 5 and 6A-6B, some applications require more than stimuli-responsivity of a volume hologram. In such applications, extending the functionality of the volume hologram by, for example, providing for interaction with a stimulus at a desired rate or in a desired form is useful and advantageous. This may be accomplished using a functional cover that regulates how the volume hologram interacts with the stimulus.

In FIG. 6A, an example embodiment wherein the security device indicates the amount of time an object has been exposed to drying conditions is illustrated. Devices of this type are useful, for example, to monitor the freshness of perishable items such as meat, produce, or other perishable good. In FIG. 6A, the device 602 includes a volume hologram 604 with a first recorded image 606 (the text “good”) and a second recorded image 608 (the text “expired”) recorded therein and a surface 610. The first recorded image 606 is recorded in the volume hologram 604 in the presence of stimulus 612, in this case water or other suitable liquid, while the second recorded image 608 is recorded onto the volume hologram 604 when the volume hologram is substantially dry. For purposes of discussing this embodiment, the first recorded image 606 is referred to as a “wet” image and the second recorded image 608 is referred to as a “dry” image. When the volume hologram 604 is hydrated, only the wet image is visible. The dry image becomes visible when the volume hologram is dehydrated.

Continuing with FIG. 6A, the sensor or device includes a functional cover 614 disposed over the surface 610 of a hydrated volume hologram 604. The functional cover 614 is permeable to water vapor but not to liquid water, and therefore, permits the volume hologram to dehydrate and protects the volume hologram from liquid water. When exposed to drying conditions, such as environmental conditions present in a food market, the functional cover permits the volume hologram to dry over time at a known rate (i.e., the stimulus 612, water, is removed). When the volume hologram is dehydrated, the dry image 608 (“EXPIRED”) is visible. Thus, the device can be used to monitor the amount of time the device has been exposed to drying conditions and, for example, to indicate the freshness of perishable items.

FIG. 6B shows an example embodiment wherein, the functional cover adds a level of specificity to the device and provides for the capacity to detect a desired form of the stimulus. In this embodiment, the device detects humidity. In FIG. 6B, the device 622 includes a volume hologram 624 with a first recorded image 626 (the text “normal humidity”), a second recorded image 628 (the text “high humidity”), and a surface 630. The first recorded image 626 is visible only in the absence of a stimulus while the second recorded image is visible only in the presence of the stimulus. For this example, the stimulus is water vapor. Similar to the example embodiment of FIG. 6A, adding or otherwise exposing the volume hologram 624 to water (i.e. hydrating) causes the volume hologram 624 to replay the wet image 628. When the volume hologram 624 is hydrated, the text “normal humidity,” changes to the text “high humidity.” However, unlike the example embodiment, in FIG. 6A, this particular application requires that the volume hologram 624 interact with water vapor 632a but not liquid water 632b. The sensor or device 622 also includes a functional cover 634 disposed over the volume hologram 624 that is permeable to water vapor 632a but impermeable to liquid water 632b. Thus, the sensor device can be used to indicate exposure to high humidity and will not be affected by exposure to liquid water.

For security applications, a first holographic image recorded in a “dry” volume hologram can serve as a mark of authenticity in the same way as a conventional embossed hologram. The additional security feature of stimuli-responsivity, which is particular to volume holograms, is desirable but may only be necessary in certain instances. For instance, a supplier takes a sample of a product at random from a batch of products to confirm the authenticity of the entire batch of product, or a bank issuer becomes aware of a defect in one of its customer's credit cards. In these instances, a “dry” image alone may not be sufficient to distinguish a genuine product from a counterfeit (i.e., an unauthorized copy of the product). At this point, it is advantageous to check that a volume hologram has stimuli-responsivity.

For example, a first image recorded by a volume hologram is viewable to a viewer before the volume hologram interacts with a stimulus. After the volume hologram interacts with the stimulus, a second image recorded in the volume hologram, rather than, or in addition to, the first image, becomes viewable.

The sensor or security device can comprise a removable cover, which can also be a functional cover as described herein. The removable cover is disposed over at least a portion of the volume hologram. The removable cover provides many of the advantages described herein with respect to other types of covers. For example, the removable cover can provide protection for physical damage caused by the environment, such as damage from abrasion. In addition, removable covers can be configured to provide additional security features, such as tamper resistance and/or single use. Generally, the removable cover protects at least a portion or substantially all of a surface of the volume hologram from interaction with the environment and/or a stimulus. When removed, the volume hologram can interact with a stimulus and a response to the stimulus can be detected.

The removable cover can be selected to permit at least a portion of the volume hologram to be viewed through the cover, by the aided or unaided human eye or a suitable detection device (e.g., complementary metal-oxide-semiconductor (CMOS) sensor, or an optical character recognition (OCR) reader). Thus, the removable cover can be substantially transparent, transmitting all wavelengths of light visible to the human eye, or can transmit some wavelengths of light while reflecting or absorbing others. If desired, the removable cover may have optical characteristics which enhance or alter the ability of an optical detector to detect, or the ability of a human eye to view, at least some portion of a holographic image. For example, a removable cover may be “tinted” with a colorant so that the removable cover interacts with a holographic image optically making the image more prominent. In other examples, the removable cover can include a magnifying lens, lenticular lens, polarizing filter, diffractive structure, wavelength filter element, and the like.

In another example, a removable cover comprises or provides a “viewing window” or “viewing portal” through which a portion of a volume hologram can be viewed, while other portions of the volume hologram are masked from view. For example, a removable cover that comprises a viewing window and a masking portion can further comprise instructions printed on the masking portion that instruct removing the removable cover from the volume hologram and exposing the volume hologram to an appropriate stimulus.

To further hinder unauthorized copying of a volume hologram, the removable cover may be birefringent. For example the removable cover may have a birefringence of at least 0.01, 0.02, 0.03, 0.04, 0.05, 0.06 or more. An example of a suitable birefringent material is polyester film, in which the birefringence may be enhanced by stretching the film in the plane of the film. In one convenient embodiment, a removable cover (e.g., a removable cover 540 of FIG. 5) has a birefringence of at least 0.01.

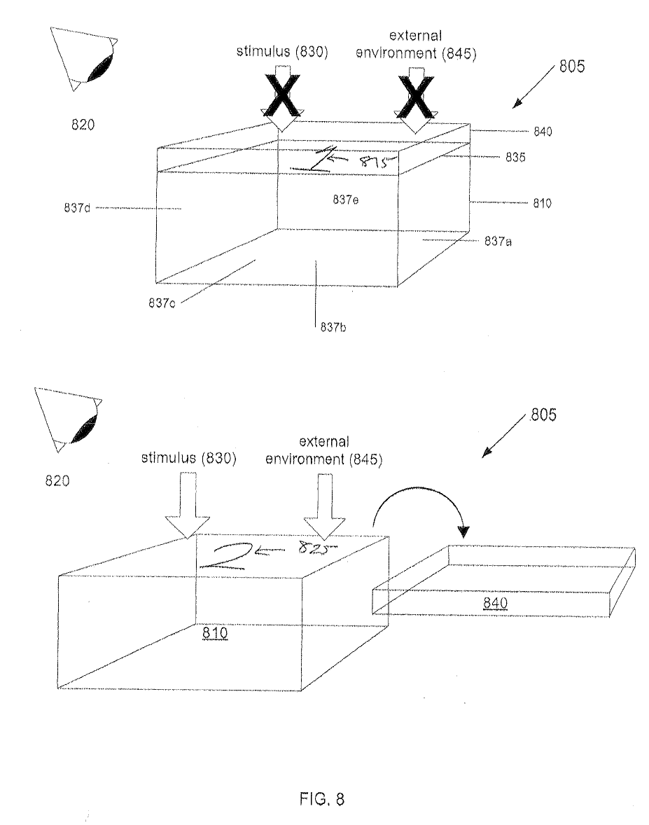

In FIG. 7A, a first example removable cover 702 is substantially rectangular in shape with a first edge 704a, second edge 704b, third edge 704c, and fourth edge 704d, generally 704. To facilitate removing the removable cover 702 from a security element, the removable cover comprises a tab 706 disposed about at least one edge of the removable cover 702. In the example illustrated in FIG. 7A, the tab 706 is disposed about the first edge 704a.

In FIG. 7B, a second example removable cover 708 is substantially circular in shape having one edge or circumference 710. To facilitate removing the removable cover 708 from a security element, a tab 712 is disposed about the circumference 710.

In FIG. 7C, a third example removable cover 714 is substantially rectangular in shape with a first edge 716a, second edge 716b, third edge 716c, and fourth edge 716d, generally 716. To facilitate removing the removable cover 714 from a security element, a tab 718 is disposed about a corner formed by the first edge 716a and the second edge 716b.

Generally, though not always, a removable cover prevents a volume hologram from interacting with a stimulus and prevents stimulus-induced changes in physical and/or optical characteristics of the volume hologram. Thus, the removable cover is generally impermeable and/or resistant to the stimulus. For example, a removable cover impermeable to a liquid stimulus may have, for example, no pores or have pores smaller than the individual liquid stimulus molecules. A removable cover which prevents a volume hologram from interacting with a stimulus may also be further characterized by “resistivity” or the ability of the removable cover to withstand repeated or constant application of the stimulus. For example, repeated or constant application of a caustic stimulus to a removable cover will not cause the removable cover to fail or otherwise breakdown. In another example, where the stimulus is pressure, constant application of pressure to a removable cover will not cause the removable cover to fail and allow the volume hologram to interact or otherwise be affected by the pressure stimulus.

The removable cover can be disposed over and attached to at least a portion of the volume hologram using a suitable adhesive to releaseably adhere the removable cover to the volume hologram. An adhesive layer can be deposited between a volume hologram and a removable cover to releaseably adhere at least a portion of the volume hologram to the removable cover. In one example, an adhesive strip deposited substantially around the perimeter of the volume hologram releaseably adheres the removable cover to the volume hologram. If desired, the adhesive can adhere tightly to both the removable cover and the volume hologram such that a portion of the volume hologram remains adhered to the removable cover when the removable cover is removed. This configuration of volume hologram, adhesive, and removable cover provides advantages for tamper resistance as described in more detail herein.

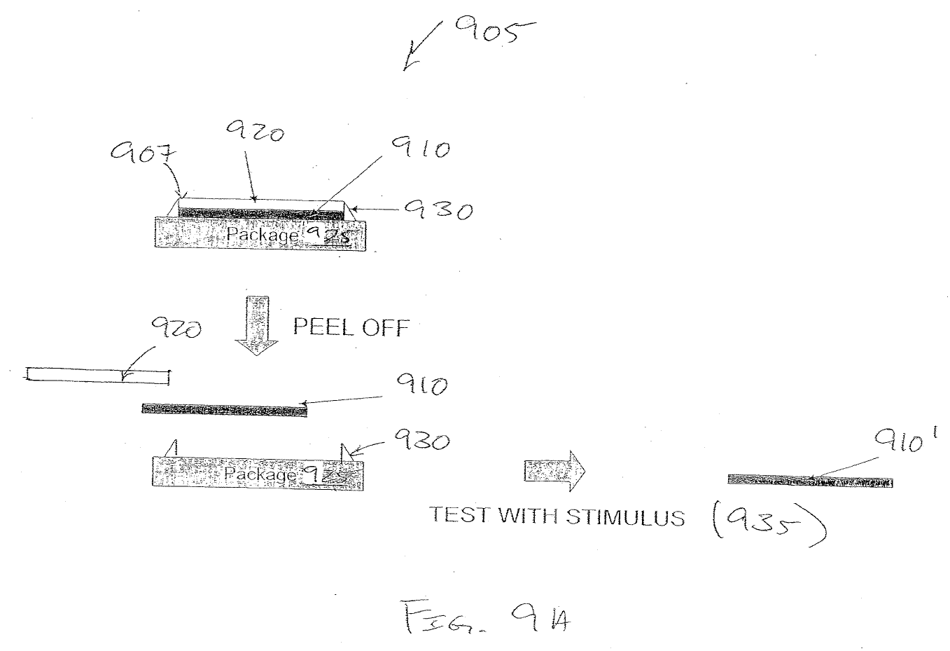

In FIG. 8, a sensor or security device 805 includes a volume hologram 810 with a first recorded image 815 presently viewable to a viewer 820 and at least one second recorded image 825 viewable after the volume hologram 810 interacts with at least one stimulus 830. The volume hologram 810 has at least one surface 835 to permit the volume hologram 810 to interact with the at least one stimulus 830. For the sake of convenience and for reasons provided below, the at least one surface 835 may be referred to as an “interactive surface.” The security element 805 also includes a removable cover 840 disposed over the at least one surface 835 of the volume hologram 810.

In contrast to the at least one surface 835, other surfaces 837a-e (generally 837) of the volume hologram 810 may not permit the volume hologram 810 to interact with the at least one stimulus 830. For example, the other surfaces 837 may be permanently altered, modified or masked to prevent interaction with the stimulus 830. As such, in some example embodiments, testing stimuli-responsivity comprises removing the removable cover 840 from the security element 805.

Accordingly, in some embodiments, a removable cover may be disposed over two or more of these surfaces. Removing any one of these removable covers from a security element permits a volume hologram to interact with at least one stimulus.

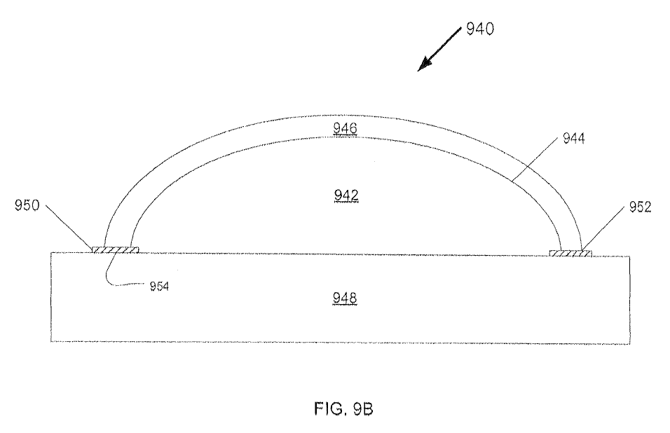

In some embodiments, the removable cover is provided by the carrier base layer that supports the volume hologram. For example, with reference to FIG. 9A, a security device 905 with a volume hologram 910 supported on a carrier base layer 920 is applied to an article of value 925 (e.g., a package) face down, so that the carrier base layer 920 (e.g., triacetate) forms a removable cover. An adhesive 930 is applied around the edges 907 of the security device 905. The adhesive 930 attaches the volume hologram 910 and removable cover (i.e., the carrier base layer 920) to the article 925, prevents the edges 907 of the volume hologram 910 from interacting with a stimulus by forming a seal (e.g., an impermeable, semi-permeable, pseudo-hermetic, hermetic seal), and preserves the physical integrity of the volume hologram 910.

A holographic image, such as a dry image, is viewable through the formed removable cover 920 (i.e., the carrier base layer). The formed removable cover 920 protects the volume hologram 910 during normal use of the security device 905, e.g., from contact with objects and liquids.

When stimuli-responsivity, in addition to the holographic image visible through the removable cover, is desired to verify that an article is genuine and authorized, the formed removable cover 920 is removed from the security device 905 and the exposed volume hologram 910 is tested for stimuli-responsivity. In some example embodiments, to test the volume hologram 910 for stimuli-responsivity, the volume hologram 910 is removed from the article of value 925, as illustrated in FIG. 9A. In other example embodiments, the volume hologram 910 is not removed from the article of value 925, but left on the article of value 925 to test the volume hologram 910 for stimuli-responsivity. Advantageously, the security device 905, in particular, the volume hologram 910 can be discarded and/or destroyed after it is tested for stimuli-responsivity, for example, by a supplier, retailer or consumer, to prevent unauthorized reuse of the volume hologram.

In another example configuration illustrated in FIG. 9B, a security element 940 includes a volume hologram 942 with an interactive surface 944, and a removable cover 946. The removable cover 946 is configured to associate the security element 940 with an article 948. In the example illustrated in FIG. 9B, the removable cover 946 includes an adhesive 950 deposited substantially about the perimeter 952 of the removable cover 946 (contrasted with the adhesive 930 of FIG. 9A deposited around the edges of the security device 905). The adhesive 950 adheres the removable cover 946 to a surface 954 of the article 948. The adhesive 950 does not, however, substantially adhere the removable cover 946 to the volume hologram 942. The adhesive 950 may be, for example, a pressure sensitive adhesive, a hot-melt adhesive, a reactive or partly reactive hot-melt adhesive or any combination thereof.

In an alternative embodiment (not shown), the removable cover 946 includes a weld area situated substantially about the perimeter 952 of the removable cover 946 to weld the removable cover 946 to the surface 954 of the article 948. In cases where both the removable cover 946 and the surface 954 are plastic or other synthetic or semi-synthetic polymerization product, any one of the following plastic welding techniques may be used, hot gas welding, speed tip welding, contact welding, hot plate welding, high frequency welding, ultrasonic welding, vibration or friction welding, spin welding, solvent welding, and the like.

In another example the removable cover is a rigid material such as a lid or cap of a container that preferably contains a transparent window for viewing the volume hologram. For example as shown in FIG. 9C, the security device 955 includes a volume hologram 960 with an interactive surface 965, and a removable cover 970, wherein the removable cover is in the form of a screw cap with a transparent window 990. The removable cover 970 can be configured to associate the volume hologram 960 to an article 975, or the volume hologram can be independently attached to the article. In the example illustrated in FIG. 9C, the removable cover 970 includes screw threads 980 to receive reciprocal or mating screw threads 985 on the article 975. In embodiments, the removable cover 970 is a screw-on cap for a bottle, for example, a medicine or pill bottle. In this example embodiment, the removable cover 970 also serves as a cover for the medicine bottle, covering the opening of the medicine bottle and sealing in contents of the medicine bottle. In this way, the security device 955, in addition to securing the article 975, also protects contents of the article 975.

The sensor or security device can be configured to hinder unauthorized copying and/or reuse. Generally, this is accomplished using a suitable adhesive that permanently adheres the volume hologram to an object and/or to a removable cover.

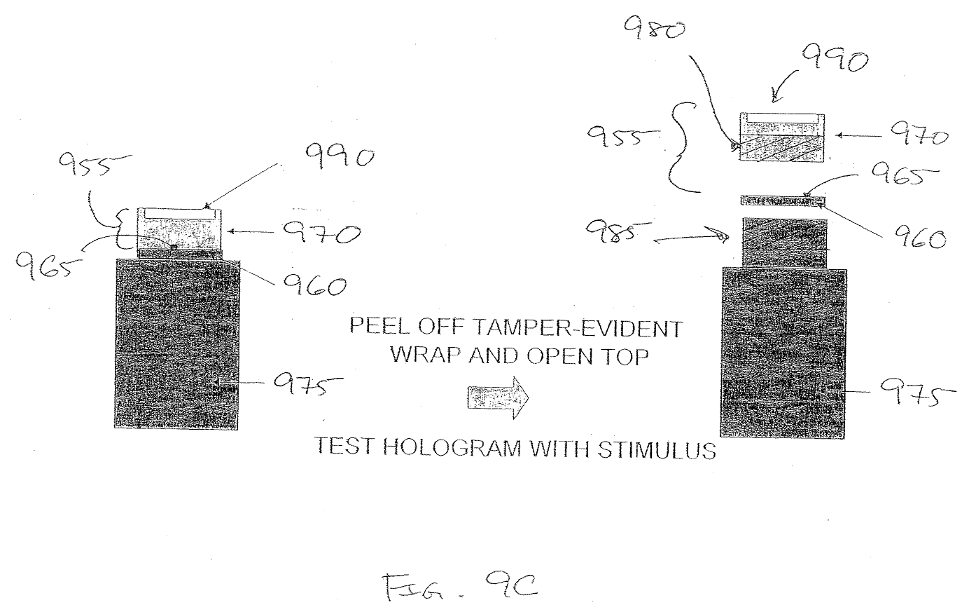

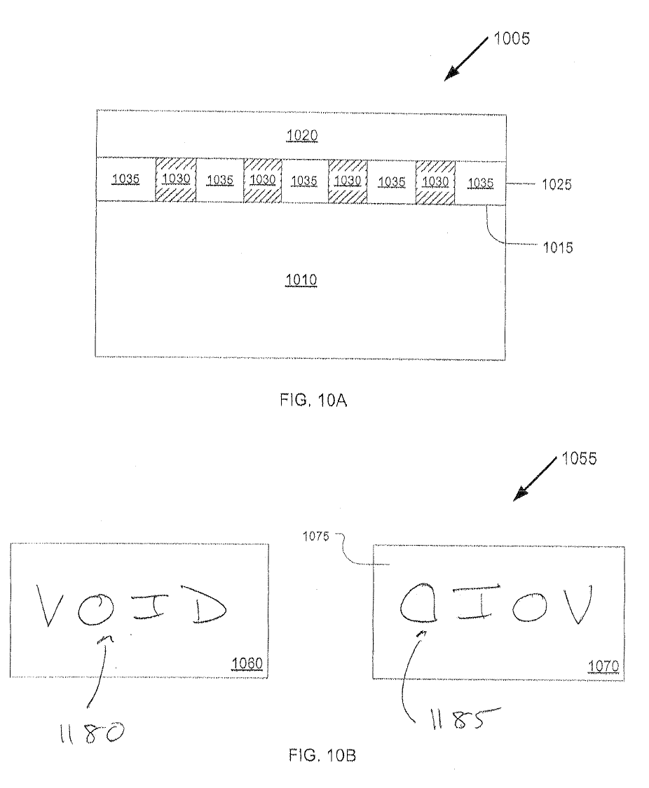

In an example embodiment illustrated in FIG. 10A, the security device comprises a volume hologram 1010, a removable cover 1020 and an adhesive layer 1025 that adheres the volume hologram to the removable cover. In FIG. 10A, the adhesive layer 1025 is not uniform, and thus, adheres the volume hologram 1010 to the removable cover non-uniformly. In particular, the adhesive layer 1025 includes gaps and/or portions 1030 that releaseably adhere the volume hologram 1010 to the removable cover 1020, these portions can be referred to as “release portion” of the adhesive layer. The adhesive layer also contains portions 1035 that permanently adhere the volume hologram 1010 to the removable cover 1020. These portions can be referred to as “non-release portions.” When the removable cover 1020 is removed from the security element (e.g., to permit the volume hologram to interact with at least one stimulus), a portion of the volume hologram 1010 is removed together with the removable cover 1020 while a portion of the volume hologram 1010 remains. Thus, removing the removable cover 1020 causes the volume hologram 1010 to be damaged in a predetermined manner, and hinders or prevents unauthorized copying and reuse of the volume hologram 1010. For example, to contact copy a volume hologram of a security element the removable cover must first be removed from the security device. However, in this example, the removable cover 1020 is configured with the above-described adhesive layer 1025. Consequently, removing the removable cover 1020 from the security element damages the volume hologram 1010, resulting in a volume hologram which has some portions missing. In this way, the removable cover 1020 hinders unauthorized copying and/or reuse of the volume hologram 1010.

In addition to hindering unauthorized copying and/or reuse of the volume hologram, this type of configuration of the sensor or security element also provide evidence of tampering or prior use. For example, in FIG. 10A, the release portions 1030 and the non-release portions 1035 may be organized in a pattern that indicates tampering or prior use, for example, the non-release portions can be form the universal symbol for “no,” namely, a circle with a diagonal line drawn across the circle. In this example, removing the removable cover will produce the no symbol in the volume hologram indicating to any person that did not personally remove the removable cover that the sensor or security device had been tampered with or previously used.

In another example illustrated in FIG. 10B, a security element 1055 includes a volume hologram 1060, a removable cover 1070, and an adhesive layer 1075. The adhesive layer 1075 includes non-release portions organized in a pattern spelling out the word “void.” By removing the removable cover 1070 from the security element 1055, the adhesive layer 1075 removes at least a portion of the volume hologram 1060 spelling out the word “void.” The end effect of removing the removable cover 1070 from the security element 1055 is that the word “void” is “relieved” 1080 into the surface of the volume hologram 1060 and “raised” 1085 from the surface of the removable cover 1070. Consequently, a counterfeit volume hologram made by contact copying the volume hologram 1060 would also include the word “void.”

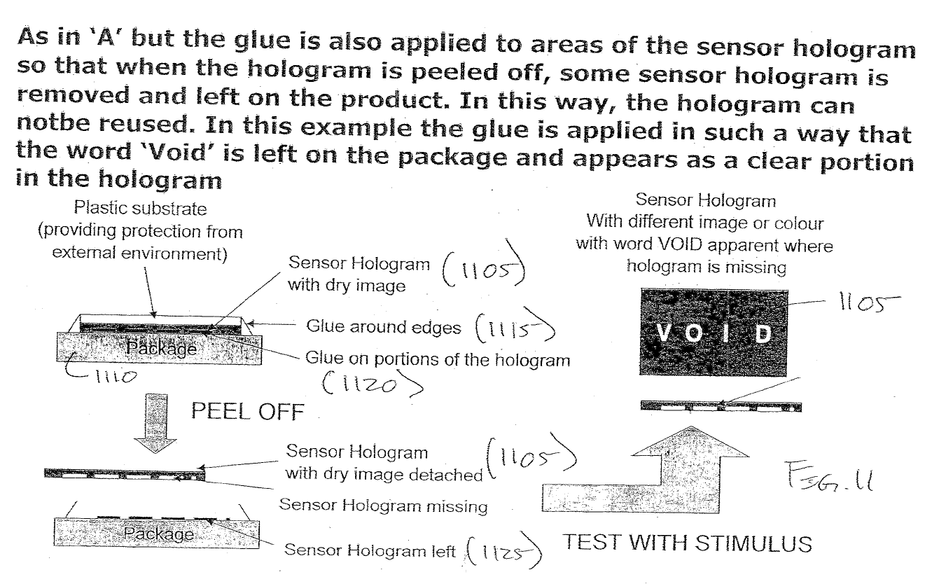

When the removable cover is formed by attaching the volume hologram to an object face down so that the carrier base layer forms a cover, as in the embodiment shown in FIG. 10A, the volume hologram can be attached to the object in a manner that hinders unauthorized copying and/or reuse. For example, as shown in FIG. 11, a volume hologram 1105 can be attached to an object 1110 using an adhesive applied around the edges of the volume hologram 1115 and to portions of the volume hologram 1120 that are in contact with the object 1110. The adhesive will non-releaseably adhere the portions of the volume hologram 1125 to the object 1110. When the volume hologram 1105 is removed from the object 1110 (e.g., to test sensor function) the portions of the volume hologram 1125 are removed and remain adhered to the object 1110. Consequently, any person that did not personally remove the volume hologram 1105 from the object 1110 would know that the volume hologram 1105 had been tampered with or previously used.

Thus, an aspect of the invention also relates to a method for preventing unauthorized reuse, copying or transfer of a holographic sensor, comprising providing a holographic sensor comprising a volume hologram comprising a holographic image, and non-releaseably attaching a portion of the volume hologram to an object, such that when the volume hologram is removed from the object, the non-releaseably attached portions of the volume hologram remain attached to the object, and wherein a physical or chemical property of the volume hologram changes when the volume hologram is in the presence of an external stimulus, thereby causing a change in the holographic image.

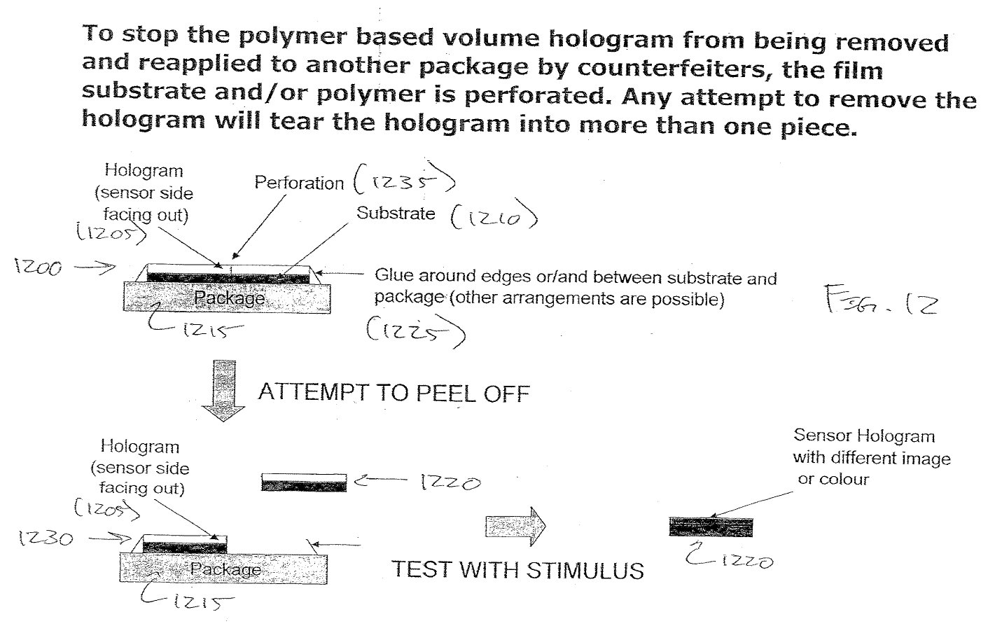

The sensor or security element can also be configured to hinder unauthorized copying, reuse and/or transfer by incorporating perforation into the volume hologram and/or carrier base layer. For example, as shown in FIG. 12 a sensor security device 1200 comprising a volume hologram 1205 and a carrier base layer 1210 can be attached to an object 1215 so that the volume hologram 1205 is exposed and a portion of the volume hologram 1220 can be removed from the object 1215. In FIG. 12 this is accomplished by adhesive 1225 applied around the edges of the volume hologram 1205. Many other approaches may be used, for example, in addition or alternatively to glue around the edges, a non-releasable portion of the volume hologram 1230 can be attached to the object using a glue that substantially permanently bonds a portion of the carrier base layer to the object, while other portions are not glued. Because the volume hologram 1205 and/or carrier base layer 1210 is perforated by a perforation 1235, when the volume hologram 1205 is removed from the object 1215 it will break along or about the perforation 1235 and the non-releasable portion of the volume hologram 1230 that is glued to the object 1215 will remain attached to the object 1215. In this way, unauthorized transfer of the sensor or security device 1200 to another object is prevented. If desired, the sensor or security device 1200 of this example embodiment can further comprise a cover, such as a functional and/or removable cover, with or without perforations.

It will be appreciated that the sensor or securing element in the example embodiment shown in FIG. 12 can be attached to the object in other ways. For example, in another example embodiment, a sensor or security device is attached to an object so that a volume hologram contacts the object and a carrier base layer forms a cover. The sensor or security device is attached to the object through glue around the edges, glue between a portion of the volume hologram and the object, or any other suitable method. Because the volume hologram and/or carrier base layer is perforated, when the volume hologram is removed from the object it will break along or about the perforated area or perforation and the portion that is glued or otherwise attached to the object will remain attached to the object.

A range of recording materials may be employed for security and sensing applications including, but not limited to silver halide based materials, dichromated gelatine based materials, photopolymerizable materials and photochromic materials. Some more detailed examples are given below.

In one example the recording material comprises photosensitive silver halide particles in a polymeric medium, which may be of gelatin. The gelatin can also be photo-cross-linked by chromium (III) ions, between carboxyl groups or gel strands. Other examples of holographic media are K-carageenan, starch, agar, agarose, polyvinyl alcohol (PVA), sol-gels (as broadly classified), hydro gels (as broadly classified), and acrylates. Further materials are polysaccharides, proteins and proteinaceous materials, oligonucleotides, ribonucleic acid (RNA), deoxyribonucleic acid (DNA), cellulose, cellulose acetate, polyamides, polyimides and polyacrylamides. Typical polymers are selected from polyvinyl alcohol, polyvinyl pyrrolidone, polyhydroxyethyl acrylate, polyhydroxyethyl methacrylate, polyacrylamides, polymethacrylamides, homopolymers or copolymers of polymerizable derivatives of crown ethers, and esters of or co- or terpolymers of polyhydroxyethyl acrylate, polyhydroxyethyl methacrylate, polymethacrylamides or polyacrylamide, optionally with other polymerizable monomers or cross linkers. In particular, copolymers of, e.g., (meth)acrylamide and/or (meth)acrylate-derived monomers are used, which may be crosslinked. Preferably, hydroxyethyl methacrylate monomer is readily polymerizable and cross-linkable. Polyhydroxyethyl methacrylate is a versatile support material since it is swellable and hydrophilic. The polymeric support medium may also contain pores by formation of the support medium in situ in the presence of a pore-forming agent, e.g., by polymerization of monomers to a polymer in situ in the presence of a pore forming agent such as gas, liquid, water and the like.

The photosensitive material such as silver halides may be disposed in the support medium by dispersing silver halide grains within a low viscous precursor of the support medium, followed by solidification of the support medium or by a sequential treatment technique, wherein the polymer film is made first and sensitive silver halide particles are added subsequently. These particles are introduced into the support medium by diffusing soluble salts into the polymer matrix where they react to form an insoluble light-sensitive precipitate. The holographic image may then be recorded.

Different liquids, such as water, aqueous solutions of sodium nitrate (NaNO₃) or other soluble salts, or ethanol, in different concentrations, are able to alter the volume of the support medium, causing its contraction or expansion. Therefore, the holographic image may be recorded after immersing the support medium containing the recording material, e.g., the silver halide particles, in an appropriate liquid, thereby leading to contraction or expansion of the support medium. Additionally, applying different liquids, e.g., those mentioned above, optionally in different concentrations, to different parts of the support medium prior to the recording of the volume hologram may therefore lead to a different response of these parts of the volume hologram to an external stimulus. To this end, in particular multicolored images may be obtained.

The polymeric support medium of the volume hologram need not contain silver halide particles in order to have a diffractive structure recorded therein. For example the recording medium may be a phase-change medium. For example, the polymeric support medium may have a polymeric holographic element disposed throughout the volume thereof, wherein the fringes of the holographic element are defined by different degrees of swellability in a liquid. These different degrees of swellability may correspond to different degrees of polymerization or cross-linking of the polymeric medium. Such holograms may be produced by a process where in a first step a polymeric matrix is formed, and in the second step, in selected parts of the matrix, a different degree or type of polymerization is caused, optionally involving a further cross-linking step. The second step may not itself form a distinct holographic grating, but a grating may be evident on swelling or contraction of the resultant material. Thus, the recording material may comprise at least two polymers distinguished in type or degree of cross-linking (the degree of cross-linking may also be zero). These polymers may be regarded being either “soft” or “hard,” depending on the degree of cross-linking. Either all, some or each of such polymers may include functional groups that are intended to react with an external stimulus. The holographic fringes, which are relatively lightly cross-linked, are able to swell when being contacted with an appropriate external stimulus, whereas the heavily cross-linked fringes are not. Such swelling may lead to either alteration in the difference of the refractive indices of both polymers or to difference of fringe spacing between that of recording and that of replay.

In general, at least one of the following is applied as an external stimulus: humidity (i.e., water vapor), water, gases, vapors, organic solvents, chemicals, solutions or dispersions of chemicals, enzymes, biological materials and combinations of two or more thereof. These stimuli may vary in degree or intensity, and may be used singly or in combination. To be responsive to more than one external stimulus, the polymeric support medium may be composed of a layered structure, each layer comprising a different material, or the recording medium may comprise different materials/compositions lying adjacent to one other in the plane of the film.

### EXAMPLE

On the first side of a 63μ polyethylene terephthalate (PET) film, a layer of silver halide emulsion of approximately 5-10μ thickness is coated. This is a very fine grain emulsion, with mono-disperse grains in the region of 10-15 nm diameter spectrally sensitized to red and green or at least one of these colors. This layer can therefore record a full color tri-stimulus hologram utilizing its sensitivity toward lasers of wavelength 647 nm, 633 nm, 561 nm, 532 nm and 491 nm, or a simpler two-color or monochromatic hologram may be recorded.

Spectral sensitization imparts a photo-speed in the emulsion which is generally from several times, up to an order of magnitude, faster than the unsensitized emulsion. Spectral sensitization is especially effective at the red end of the spectrum where the raw silver halides exhibit little or no natural sensitivity to light. However, the addition of a green sensitizing dye to an emulsion such as the COLOUR HOLOGRAPHIC BBV520 material will improve the sensitivity to light of wavelength 491 nm (blue-green) by approximately four times compared with the natural blue sensitivity of the emulsion in the BB640 plates.

On the second side of the 63μ PET film, after drying the first coated layer on the first side, is also coated a layer of silver halide emulsion, but this layer is at a lower thickness, e.g., of 2-4μ only. This emulsion contains a higher percentage of silver halide relative to its gelatin quantity and optionally a water soluble polymer or bulking agent which will later wash from the layer during development. Optionally, in one preferred embodiment, the emulsion on the second side has a marginally larger grain size of 15-20 nm. This increase in grain size influences a higher natural photo speed in the emulsion as regards exposure to blue and violet light. It needs to contain no spectral sensitizer. Optionally, the emulsion could be treated with dyes suitable to enhance only the violet sensitivity of the emulsion.

Whereas the laser(s) used to produce a first overt image in the emulsion coating on the first side of the film are all of wavelengths which are highly visible to the human eye, they are gathered to some extent at the low frequency side of the visible spectrum. Conversely, the laser used to create an image in the emulsion on the second side of the film, by a similar hologram-recording technique such as the contact copying of a reflection master hologram, which will comprise the covert part of the security device, has a second, longer wavelength for example from a krypton (Kr) ion gas laser emitting at the violet line 413 nm, or a diode pumped solid state laser equivalent working in the violet area between 400 nm and 420 nm, such as the 25 mW 405 nm photon laser diode from PHOTONIC PRODUCTS LTD, the UK optoelectronics device manufacturer.

The image created by the violet laser will be subjected to approximately 3-5% layer shrinkage upon chemical processing under typical processing conditions and this may be deliberately increased, for example by the addition to the coating process of a material which washes from the assembly during processing. This layer shrinkage will ensure that its image will reconstruct at a wavelength of less than 400 nm and as such will not be visible to the observer under ordinary conditions. However, the application of a chemical stimulus such as an aqueous solution of isopropyl alcohol (IPA) results in the rapid and controlled swelling of the layer by some 35% so that a strong green image appears in the designated position, which is preferably marked as described above by an outline drawing of a security icon in the overt hologram in the emulsion on the first side of the film.

In the emulsion on the first side of the film are also all of the image components which may take the form of an elaborate full color hologram with all of the animation, three-dimensional parallax and other effects commensurate with a powerful security device. The emulsion on the first side of the film also records at a low level of efficiency the violet image which is directed at the emulsion on the second side. However, the emulsion of the first side is laminated after processing with an adhesive which will allow the label to be permanently affixed to a product or document as a security seal. This adhesive permanently seals the emulsion to the product substrate and effectively prevents any ingress of moisture or other species into the label. Thus the invisible security logo remains permanently invisible to the observer, and is not activated by any surface treatment applied to the exposed emulsion on the second side of the film. In other embodiments, instead of the adhesive layer the system may be attached to the surface of an item by a film or layer over the entire hologram, with a window to expose all but the periphery of the upper side of the hologram to the stimulus.

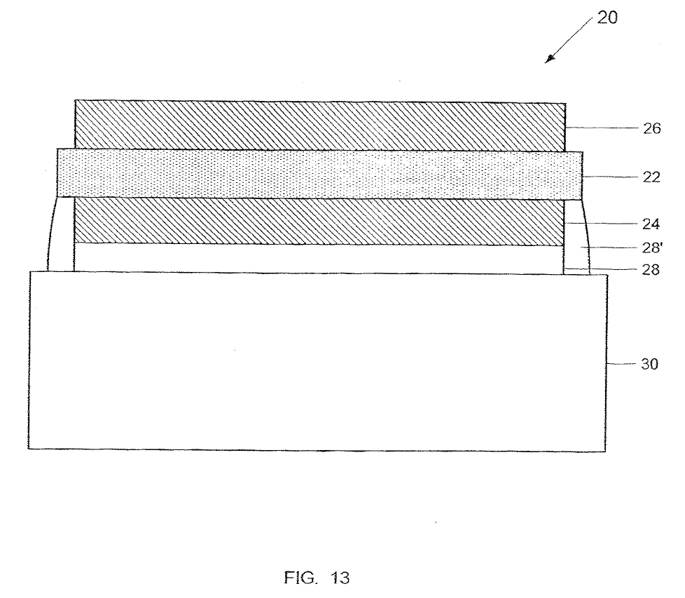

FIG. 13 shows the application of a two sided film coating with holographic images (system) 20 as applied to a security document 30 or other object of value. The system 20 comprises an impermeable carrier base 22 with a first emulsion 24 protected from the external environment and a second emulsion 26 exposed to the external environment and subject to chemical stimulus. The second emulsion 26 of one side of the system 20 is subject to chemical interaction with an applied chemical reagent, which may cause the appearance or change in a holographic image. The first emulsion 24 of another side of the system 20 bearing a permanent or consistent holographic security image is protected from chemical stimulation by the presence of the carrier base 22 and an adhesive layer 28 (and/or in combination with an adhesive 28′), which sandwich the first emulsion 24. Any suitable adhesive may be employed as the adhesive layer 28 including, but not limited to, a pressure-sensitive adhesive, a reactive or partly-reactive hot-melt adhesive, or a combination thereof.

Applications of the above-described techniques are not limited to security applications, and, in particular, include sensing systems where the image which changes in response to an external stimulus or senses a property of the stimulus, for example a level of a substance to be analyzed (described in greater detail below).

Although in some of the described embodiments the changing image fits within a region of the “permanent” image, in other embodiments the two images may overlay one another. For example the “permanent” image may display a corporate logo and the changing image may, for example, overlay the word “valid;” in still other embodiments, illumination and/or viewing angle selectivity for one or both of the “permanent” and changing images may also be provided.

Applications for the security hologram technology include, but are not limited to: bank notes, passports, identification documents, smartcards, driving licenses, share certificates, bonds, checks, check cards, packaging materials, for example pharmaceutical packaging materials, decorative materials, brand products, and labeling of any other product which it is desirable to secure, for example household appliances, spare parts, shoes, clothes, sporting goods, computer, hardware and software, recordable media such as digital versatile discs or digital video discs (DVDs), pharmaceuticals, cosmetics, cigarettes, tobacco, and the like.

No doubt many other effective alternatives will occur to the skilled person. For example, although the described applications of the techniques relate mainly to an external stimulus in the form of a liquid or gas, the skilled person will understand that the techniques described may also be used with other forms of external stimulus, including but not limited to: non-ionizing radiation, electromagnetic radiation, light of particular wavelengths, radioactive radiation, electrical field, electrical charge, electrical potential, magnetic field and other magnetic stimuli, and physical stimuli, for example pressure and/or temperature.

While this invention has been particularly shown and described with references to example embodiments thereof, it will be understood by those skilled in the art that various changes in form and details may be made therein without departing from the scope of the invention encompassed by the appended claims.

1. A volume reflection hologram in which images are recorded, the hologram comprising: a first image in a first physical region of the hologram and a second image in a second physical region of the hologram different from the first physical region, the second physical region of the hologram being responsive to an external stimulus to change an appearance of the second image, and the hologram being configured to protect the first physical region of the hologram physically from the external stimulus in a manner preventing change of an appearance of the first image.

2. A volume reflection hologram as claimed in claim 1 wherein the first and second physical regions comprise different portions of a surface area of the hologram, and wherein the hologram has a protective covering over the first physical region to protect the first physical region of the hologram physically from the external stimulus.

3. A volume reflection hologram as claimed in claim 2 wherein the protective covering comprises a protective film substantially covering the hologram, and wherein the protective film is permeable or perforated where the protective film covers the second physical region of the hologram.

4. A volume reflection hologram as claimed in claim 3 wherein the protective covering has a birefringence of at least 0.01.

5. A volume reflection hologram as claimed in claim 4 wherein the protective covering blocks at least 10% of incident light at a wavelength of less than 400 nm.

6. A volume reflection hologram as claimed in claim 1 is in the form of a sticker.

7. A volume reflection hologram as claimed in claim 1 wherein the hologram comprises a film carrier bearing first and second holographic recording media on opposite respective first and second surfaces of the carrier, and wherein the first and second physical regions of the hologram comprise the first and second holographic recording media respectively.

8. A volume reflection hologram as claimed in claim 7 wherein the first physical region of the hologram has an adhesive layer or coating to enable the hologram to be attached to a surface to protect the first physical region of the hologram physically from the external stimulus.

9. A volume reflection hologram as claimed in claim 7 wherein the first and second holographic recording media have peak recording sensitivities at different wavelengths.

10. A volume reflection hologram as claimed in claim 9 wherein the second holographic recording medium has a peak recording sensitivity at a shorter wavelength than the first recording medium.

11. A volume reflection hologram as claimed in claim 10 wherein the second holographic recording medium has a peak recording sensitivity at a wavelength of less than 400 nm.

12. A volume reflection hologram as claimed in claim 7 wherein the second recording medium has a thickness of less than the first recording medium.

13. A volume reflection hologram as claimed in claim 12 wherein the first recording medium has a thickness in the range 5 μm to 20 μm.

14. A volume reflection hologram as claimed in claim 12 wherein the second recording medium has a thickness of less than 5 μm.

15. A volume reflection hologram as claimed in claim 7 wherein the first and second holographic recording media both comprise silver halide recording media, and wherein the second recording medium has an average grain size larger than that of the first recording medium.

16. A volume reflection hologram as claimed in claim 1 wherein the first image has a delineated region, and wherein the second image is positioned at least partially within the delineated region.

17. A volume reflection hologram as claimed in claim 1 wherein the second image is substantially invisible to a human observer and changes colour towards a longer wavelength colour in response to the external stimulus to thereby become apparent to a human observer.

18. A volume reflection hologram as claimed in claim 1 wherein the stimulus is in the form of a liquid or a liquid bearing gas.

19. A security element or device comprising a hologram as claimed in claim 1.

20. An article having a surface to which is attached a hologram as claimed in claim 1.

21. Use of a security element or device according to claim 19 for at least one of the following applications: verification, identification, authentication, or anti-counterfeiting purposes.

22. Use of a security element or device according to claim 19 for at least one of the following applications: verification, identification, authentication, anti-counterfeiting of a product.

23. A product carrying a security element or device according to claim 19.

24. A product according to claim 23 selected from a group consisting of: a bank note, a passport, an identification document, a smart card, a driving license, a share certificate, a bond, a cheque, a cheque card, a tax banderole, a postage stamp, a ticket, a credit card, a debit card, a telephone card, a lottery ticket, a gift voucher, a packing material, a decorative material, a brand product and another product that has to be secured.

25. A security element or device according to claim 19 including a further security element, in particular comprising one or more of the following: a water mark, a laser engraving, a planchette, a fibre, a fluorescent particle or fibre, an infra-red (IR) or ultra-violet (UV) active colorant, a magnetic particle, an electrically conductive particle, an optically variable pigment, a liquid crystal polymer (LCP) pigment, a chemical additive observable by irradiation with light of a particular wavelength or by chemical reaction or by manipulation of the substrate, a deoxyribonucleic acid (DNA)- and/or Bio-coding material, an organic or inorganic taggant or similar.

26. A security element or device according to claim 19 including a further second security element, in particular comprising one or more of a hologram, a kinegram, a laser engraving, a radio-frequency identification (RFID) element, an optically variable printing/and or an optically variable system of optically variable pigments, an optically variable thin film structure and/or liquid crystal polymers, a microtext, guilloches, a magnetic feature, an electrically conductive feature, an IR or UV active feature, a photoluminescent feature, an electroluminescent feature, a photochromic feature, a thermochromic feature, a hydrochromic feature, a tribochromic feature, a piezochromic feature, a deoxyribonucleic acid (DNA)- and/or Bio-coding feature or similar.

27. A method of verification using the method of claim 21, the method detecting a change in the appearance of the second image.

28. A method as claimed in claim 27 wherein the detecting is performed by a machine.

29. A security element or device as claimed in claim 19 wherein the element or device is machine readable.

30. A method of displaying two images using a volume hologram, the method comprising: protecting a first physical region of the hologram physically from an external stimulus in a manner having the first image visible in a substantially unchanging form whilst the appearance of a second image is changed by the external stimulus.

31. A holographic recording system for recording a volume reflection hologram comprising two images, a first image in a first physical region of the hologram and a second image in a second physical region of the hologram different from the first physical region, wherein the second physical region of the hologram being responsive to an external stimulus to change an appearance of the second image, the holographic recording system comprising means for protecting the first physical region of the hologram physically from the external stimulus.

32. A holographic recording system as claimed in claim 31 wherein the first and second physical regions comprise different portions of a surface area of a holographic recording medium, and wherein the means for protecting the first physical region of the hologram physically from the external stimulus comprises a protective covering over the first physical region.

33. A holographic recording system as claimed in claim 31 wherein the system comprises a film carrier bearing first and second holographic recording media on opposite respective first and second surfaces of the carrier, wherein the first and second physical regions of the hologram comprise the first and second holographic recording media respectively, and wherein the means for protecting the first physical region of the hologram physically from the external stimulus comprises an adhesive layer or coating on the first physical region to enable the hologram to be attached to a surface.

34. A holographic recording system as claimed in claim 31 wherein the system comprises a film carrier bearing first and second holographic recording media on opposite respective first and second surfaces of the carrier, wherein the first and second physical regions of the hologram comprise the first and second holographic recording media respectively, and wherein the means for protecting the first physical region of the hologram physically from the external stimulus comprises a layer over the carrier bearing the holographic recording media for sealably attaching the system to a surface, the layer having a window to expose the second physical region of the hologram to the external stimulus.

35. A holographic sensor comprising:
a volume hologram comprising a holographic image and a surface; and
a functional cover disposed over at least a portion of the surface,
wherein a physical or chemical property of the volume hologram changes when the volume hologram is in the presence of an external stimulus, thereby causing a change in the holographic image, and wherein the functional cover regulates the interaction of the volume hologram with the stimulus when the sensor is in the presence of the stimulus.

36. The holographic sensor of claim 35 wherein the volume hologram is composed of a silver halide-based material and the functional cover blocks at least 10% of incident light at a wavelength of less than 400 nanometres.

37. The holographic sensor of claim 35 wherein the functional cover is substantially transparent.

38. The holographic sensor of claim 35 wherein the functional cover is abrasion resistant.

39. The holographic sensor of claim 35 wherein the functional cover is birefringent.

40. The holographic sensor of claim 35 wherein the functional cover regulates the interaction of the volume hologram with the external stimulus.

41. The holographic sensor of claim 40 wherein the stimulus exists in vapor form and in liquid form, and the functional cover is permeable to the vapor form but impermeable to the liquid form.

42. The holographic sensor of claim 41 wherein the functional cover is permeable to water vapor but impermeable to liquid water.

43. The holographic sensor of claim 35 wherein the functional cover is a removable cover.

44. The holographic sensor of claim 35 wherein the volume hologram comprises a first image in a first physical region of the volume hologram and a second image in a second physical region of the volume hologram different from the first physical region, and wherein the hologram is configured to protect the first physical region of the hologram physically from the external stimulus, and the functional cover is disposed over the second physical region.

45. A holographic sensor comprising:
a volume hologram comprising a holographic image and a surface; and
a removable cover disposed over at least a portion of the surface,
wherein a physical or chemical property of the volume hologram changes when the volume hologram is in the presence of an external stimulus, thereby causing a change in the holographic image.

46. The holographic sensor of claim 45 wherein the volume hologram is composed of a silver halide-based material and the removable cover blocks at least 10% of incident light at a wavelength of less than 400 nanometres.

47. The holographic sensor of claim 45 wherein the removable cover is substantially transparent.

48. The holographic sensor of claim 45 wherein the removable cover is abrasion resistant.

49. The holographic sensor of claim 45 wherein the removable cover is birefringent.

50. The holographic sensor of claim 45 wherein the removable cover is non-porous to the external stimulus.

51. The holographic sensor of claim 45 further comprising an adhesive between the volume hologram and the removable cover that releasablely adheres at least a portion of the volume hologram to the removable cover.

52. The holographic sensor of claim 45 wherein the removable cover further comprises an adhesive area substantially about the perimeter of the removable cover to adhere the holographic sensor to the surface of an article.

53. The holographic sensor of claim 45 wherein the removable cover further comprises a weld area substantially about the perimeter of the removable cover to weld the holographic sensor to the surface of an article.

54. The holographic sensor of claim 45 wherein the removable cover further comprises screw threads to receive reciprocal screw threads of an article.

55. The holographic sensor of claim 54 wherein the removable cover is a screw-on cap or lid.

56. The holographic sensor of claim 45 wherein the holographic sensor further comprises an adhesive layer between the removable cover and the volume hologram, the adhesive layer comprising release portions that releaseably adhere portions of the volume hologram to the removable cover and non-release portions that non-releaseably adhere portions of the volume hologram to the removable cover.

57. The holographic sensor of claim 56 wherein the release portions and the non-release portions are arranged in a pattern, such that when the removable cover is removed a portion of the volume hologram in the form of the pattern remains associated with the removable cover.

58. The holographic sensor of claim 45 further comprising at least one tab disposed about at least one edge of the removable cover to facilitate removing the removable cover from the sensing element.

59. The holographic sensor of claim 45 wherein the removable cover is a functional cover that regulates interaction of the volume hologram and the external stimulus.

60. The holographic sensor of claim 45 wherein the volume hologram comprises a first image in a first physical region of the volume hologram and a second image in a second physical region of the volume hologram different from the first physical region, and wherein the hologram is configured to protect the first physical region of the hologram physically from the external stimulus, and the removable cover is disposed over the second physical region.

61. A holographic sensor comprising:
a volume hologram comprising a holographic image; and
a carrier base layer;
wherein the volume hologram, the carrier base layer, or the volume hologram and the carrier base layer are perforated by perforations in a manner that when a portion of the holographic sensor is non-releaseably attached to an object, the holographic sensor breaks on or about the perforations, and wherein a physical or chemical property of the volume hologram changes when the volume hologram is in the presence of an external stimulus, thereby causing a change in the holographic image.

62. A method for preventing unauthorized reuse, copying or transfer of a holographic sensor, comprising:
providing a holographic sensor comprising a volume hologram comprising a holographic image, and
non-releaseably attaching a portion of the volume hologram to an object, in manner that the non-releaseably attached portions of the volume hologram remain attached to the object when the volume hologram is removed from the object, and wherein a physical or chemical property of the volume hologram changes when the volume hologram is in the presence of an external stimulus, thereby causing a change in the holographic image.
